(19) United States
(12) Patent Application Publication
(10) Pub. No.: US 2026/0172810 A1
(43) Pub. Date: Jun. 18, 2026

(54) Smart Protection of Home Network Resources by Self-invalidation of Physical Subscriber Identity Module (pSIM) and/or Embedded Subscriber Identity Module (eSIM)

(71) Applicant: T-Mobile Innovations LLC, Overland Park, KS (US)

(72) Inventors: Kyeong Hun AN, Sammamish, WA (US); Zoltan HOMORODI, North Bend, WA (US); Nilesh RANJAN, Sammamish, WA (US)

(21) Appl. No.: 18/985,011

(22) Filed: Dec. 17, 2024

(51) Int. Cl. H04W 8/18; H04W 8/20

(52) U.S. Cl. CPC H04W 8/183; H04W 8/205

(57) ABSTRACT

A method implemented in a wireless communication device. The method comprises transmitting, to a network, a network connection request comprising an international mobile subscriber identity (IMSI) that is stored in an embedded subscriber module (eSIM) profile on an embedded universal integrated circuit card (eUICC) in the wireless communication device; receiving, from the network, a network connection response indicating a network rejection due to the IMSI being unassociated with an active subscription registered with the network; incrementing a counter based on the network rejection due to the IMSI being unassociated with an active subscription registered with the network and a determination that the network rejection is from a home network of the wireless communication device; invalidating the IMSI in the eSIM profile based on the counter satisfying a threshold value; and refraining from requesting to connect to the home network based on the IMSI in the eSIM profile being invalid.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A mobile network operator (MNO) is a telecommunications entity that provides mobile services to its customers. The mobile services may include voice calls and/or data transfer over a wireless communication network (e.g., a carrier network operated by the MNO). The wireless communication network may include a radio access network (RAN) and a core network (CN) that connects the RAN to other networks. The RAN may include a plurality of cell sites distributed across a geographical area. A wireless communication device, which may also be referred to as user equipment (UE), a user device, or a mobile device, may subscribe to services provided by the MNO. The wireless communication device may access the services by establishing a radio connection with the RAN and completing a network connection process and an authentication process with the CN. To that end, the wireless communication device may include a subscriber identity module (SIM) to store a variety of subscription information, such as subscriber identify information, network information, authentication information, and other data, that enable the wireless communication device to access the subscribed services.

### SUMMARY

In an embodiment, a method of protecting home network resources by self-invalidating an embedded subscriber identity module (eSIM) profile at a wireless communication device is disclosed. The method includes transmitting, by a radio transceiver of the wireless communication device, to a core network, a network connection request comprising an international mobile subscriber identity (IMSI) that is stored in an eSIM profile on an embedded universal integrated circuit card (eUICC) of the wireless communication device; receiving, by the radio transceiver, from the core network, a network connection response indicating a network rejection due to the IMSI being unassociated with an active subscription registered with the core network; receiving, by a SIM application executing on the eUICC, a network rejection event indicating the network rejection due to the IMSI being unassociated with an active subscription registered with the core network; incrementing, by the SIM application, a counter based on the network rejection event indicating the network rejection due to the IMSI being unassociated with an active subscription registered with the core network and a determination that the network rejection is from a home network of the wireless communication device, wherein the core network is associated with the home network; comparing, by the SIM application, the counter to a threshold value; invalidating, by the SIM application, the IMSI in the eSIM profile based on the counter satisfying the threshold value; and refraining, by the radio transceiver, from requesting to connect to the home network based on the IMSI in the eSIM profile being invalid.

In another embodiment, a wireless communication device is disclosed. The wireless communication device includes a subscriber identity module (SIM) to store a subscriber identification code associated with the wireless communication device; a user interface (UI); at least one processor; at least one non-transitory memory; and a SIM application comprising instructions stored in the at least one non-transitory memory, which when executed by the at least one processor, causes the SIM application to determine that a number of consecutive network connection rejections due to the subscriber identification code being unassociated with an active subscription registered with a home network of the wireless communication device satisfies a threshold value; store, based on the determining, in the SIM, a copy of the subscriber identification code having a valid subscriber identification code value; invalidate, based on the determining, the subscriber identification code in the SIM by setting the subscriber identification code to an invalid subscriber identification code value after storing the copy of the subscriber identification code; receive, via the UI, a command to restore the subscriber identification code in the SIM; restore, based on the command, the subscriber identification code in the SIM to the stored copy of the subscriber identification code; and a radio transceiver to refrain from requesting to connect to the home network based on the subscriber identification code in the SIM having the invalid subscriber identification code value; and transmit, to the home network, a network connection request based on the subscriber identification code in the SIM being restored to the valid subscriber identification code value.

In yet another embodiment, a method of protecting home network resources by self-invalidating a removable physical subscriber identity module (pSIM) card at a wireless communication device is disclosed. The method includes transmitting, by a radio transceiver of the wireless communication device, to a network, a network connection request comprising an international mobile subscriber identity (IMSI) that is configured on the removable pSIM card at the wireless communication device; receiving, by a SIM application executing on the pSIM card, based on the network connection request, a network rejection event indicating a network rejection due to the IMSI being unassociated with an active subscription registered with the network; incrementing, by the SIM application, a counter based on the network rejection due to the IMSI being unassociated with an active subscription registered with the network and a determination that the network corresponds to a home network of the wireless communication device; invalidating, by the SIM application, the IMSI in the pSIM card based on the counter satisfying a threshold value; and bypassing, by the radio transceiver, a network connection request transmission to the home network based on the IMSI in the pSIM card being invalid.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a network system according to an embodiment of the disclosure.

FIG. 2 is a sequence diagram illustrating an example method for providing smart protection of home network resources by self-invalidation of a physical subscriber identity module (pSIM) card or an embedded subscriber identity module (eSIM) profile at a wireless communication device according to an embodiment of the disclosure.

FIG. 3 is a flow chart of a method according to an embodiment of the disclosure.

FIG. 4 is a flow chart of another method according to an embodiment of the disclosure.

FIG. 5 is a flow chart of yet another method according to an embodiment of the disclosure.

FIG. 6A and 6B are block diagrams of a fifth generation (5G) network according to an embodiment of the disclosure.

FIG. 7 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As discussed above, a wireless communication device may include a subscriber identity module (SIM) to store various subscription information for use in accessing services provided by a mobile network operator (MNO). In one example, the SIM may be in the form of a physical subscriber identity module (pSIM) card that is removable from the wireless communication device. For instance, the wireless communication device may include a slot in which a pSIM card can be inserted. A pSIM card may be configured with information associated with a specific MNO. In another example, the SIM may be in the form of an embedded subscriber identity module (eSIM) profile configured on an embedded UICC (eUICC) that is embedded in (or integrated into) the wireless communication device. A eUICC may generally be configured with multiple eSIM profiles, each specific to a respective MNO.

A pSIM card or an eSIM profile may store a variety of subscription information. As an example, a pSIM card or an eSIM profile may store a subscriber identification code (e.g., an international mobile subscriber identity (IMSI)) that identifies a user of the wireless communication device in the respective MNO’s network (e.g., carrier network). In some examples, a pSIM card or an eSIM profile may include a SIM application (e.g., a software program code) stored in memory of the respective pSIM card or eUICC and executed by a processor of the respective pSIM card or eUICC. The SIM application may manage tasks specific to the respective MNO or carrier network.

As used herein, the term “home network” may refer to a network to which a user of the wireless communication device has a subscription. A home network may include a radio access network (RAN) and a core network (CN) that connects the RAN to other networks (e.g., the Internet, private network(s), public network(s)). In some instances, a home network may be referred to as a home public land mobile network (HPLMN). In some instances, one or more other networks may be considered by the wireless communication device as equivalent to the home network and may be referred to as equivalent home public land mobile network (EHPLMN(s)). As used herein, the term “roaming network” may refer to a network operated by a roaming partner of an operator that operates a home network. In some instances, a roaming network may be referred to as a visiting public land mobile network (VPLMN). Generally, a wireless communication device may access services provided by a home network of the wireless communication device or a roaming network.

In some instances, the subscription of a wireless communication device may be deactivated on the network side (e.g., by the MNO). In other words, the pSIM card or the eSIM profile at the wireless communication device is deactivated by the network. There may be a variety of reasons for the deactivation, for example, due to non-payment of bills, end of a contract period, etc. However, the pSIM card or the eSIM profile in the wireless communication device may be unaware of the deactivation on the network side. As such, when the wireless communication device is turned on and still carries the deactivated pSIM card or the deactivated eSIM profile, the wireless communication device may continue to attempt to connect to the home network. This causes the home network to continue to receive connection requests from the wireless communication device, process the connection requests, only to find out that the subscription (the pSIM card or the eSIM profile) has been deactivated. The home network may then have to transmit back a network rejection for each connection request. The operations performed by the home network to process and reject these repetitive connection requests (from the wireless communication device with the deactivated pSIM card or the deactivated eSIM profile) cause the home network to consume a heavy amount of network and processing resources unnecessarily.

The present disclosure provides a technical solution to the aforementioned technical problems in the technical field of SIM configurations to prevent the unnecessary and heavy consumption of home network resources during the process of continually rejecting network connection requests from wireless communication devices with deactivated SIMs (e.g., a deactivated pSIM card or a deactivated eSIM profile). In particular, a SIM application on a pSIM card or an eSIM profile of a wireless communication device may be configured to identify when network connection requests are rejected by a home network of the wireless communication device due to the respective pSIM card or the eSIM profile being deactivated. To that end, the home network may provide a reason for rejecting a network connection request (e.g., a network rejection code) along with a network connection rejection response. To ensure that the network connection rejection is indeed due to the pSIM card or the eSIM profile being deactivated on the network side, the SIM application may maintain a counter to count the number of consecutive network connection rejections received from the home network due to the pSIM card or the eSIM profile being deactivated. When the counter reaches a certain threshold value (e.g., 10, 15, 20, 30, 50, 70, 100 or more), the SIM application may invalidate the pSIM card or the eSIM profile. The invalidation may include setting the IMSI in the pSIM card or the eSIM profile to an invalid IMSI value (e.g., including all 0xFFs or a null value). After invalidating the IMSI, the SIM application may refresh (e.g., restart) the pSIM card or the eSIM profile and/or the wireless communication device. After the refresh, the wireless communication device may not recognize the invalid IMSI value, and thus may stop attempting to connect to the network.

As mentioned above, a wireless communication device may include a pSIM card inserted into the wireless communication device and/or an eSIM profile configured on an eUICC embedded into the wireless communication device. The pSIM card or the eSIM profile may include an IMSI that identifies the wireless communication device in a home network subscribed to by the wireless communication device. The wireless communication device may include a radio transceiver to transmit a network connection request to a CN, where the network connection request may include the IMSI that is stored in the pSIM card or the eSIM profile. For instance, the radio transceiver may read the IMSI from the pSIM card or the eSIM profile. In response to the network connection request, the radio transceiver may receive a network connection response indicating a network rejection (e.g., a network rejection code) due to the IMSI being unassociated with any active subscription registered with the CN. That is, the IMSI is unknown to the CN or inactive in the CN. An IMSI may be unknown to the CN or unidentified by the CN when the IMSI is not stored in association with an active subscription registered with the CN (or more specifically, the IMSI is not stored in a datastore (e.g., a home location register (HLR)) that stores information of active subscribers associated with the CN). An IMSI may be inactive in the CN when the IMSI is stored in the datastore of the CN, but a subscription with the CN identified by the IMSI is deactivated. The network connection rejection may also indicate information (e.g., a mobile country code (MCC) and a mobile network code (MNC)) identifying the CN that generated the network rejection.

The SIM application may register to be notified of a network rejection event. Accordingly, in response to receiving the network connection rejection, the radio transceiver may trigger a network rejection event. The network rejection event may include the network rejection code and the MCC and MNC associated with the CN (that rejected the network connection request), all of which are included in the network connection rejection. Upon the SIM application receiving the network rejection event, the SIM application may determine whether the network rejection is due to the IMSI being unassociated with any active subscription registered with the home network. Generally, a network may utilize various network rejection codes (e.g., numerical values) to indicate different rejection reasons. For instance, the CN may utilize a specific network rejection code (e.g., 12) to indicate a rejection due to an IMSI being unassociated with any active subscription registered with the CN (or an HLR of the CN). Thus, to determine whether the network rejection is due to the IMSI being unassociated with any active subscription registered with the CN, the SIM application may compare the network rejection code in the network rejection event to the specific network rejection code that is predefined to be associated with the IMSI being unassociated with any active subscription registered with the CN. Further, the SIM may store information associated with the home network of the wireless communication device (e.g., a home MCC and a home MNC). Thus, to determine whether the network rejection is from the home network, the SIM application may compare the MCC and the MNC in the network rejection event respectively to the home MCC and home MNC stored in the pSIM card or the eSIM profile. If there is a match between the MCC of the CN and the home MCC and a match between the MNC of the CN and the home MNC, then the CN corresponds to the home network of the wireless communication device.

In an embodiment, the SIM application may utilize a counter to track the number of consecutive network connection rejections that are received from the home network and due to the IMSI being unassociated with any active subscription registered with the home network. For instance, if the SIM application determines that the network connection rejection is due to the IMSI being unassociated with any active subscription registered with the CN and that the CN (that rejected the network connection request) is the home network, the SIM application may increment the counter (e.g., by 1). The SIM application may compare the counter to a threshold value. The threshold value may represent the maximum number of consecutive network connection rejections that are due to the IMSI being unassociated with any active subscription registered with the home network before the SIM application may invalidate the IMSI. In some instances, the threshold value may be configurable (e.g., adapt to network conditions). If the SIM application determines that the counter satisfies (e.g., equals or exceeds) the threshold value, the SIM application may invalidate the IMSI in the pSIM card or the eSIM profile by setting the IMSI in the respective pSIM card or the eSIM profile to an invalid IMSI value. In an example, the IMSI is a string of digits (e.g., including a mobile country code (MCC), a mobile network code (MNC), and a mobile subscriber identity (MSIN)), and the invalid IMSI value may have a value of 0xFF for all digits (e.g., a 15-bytes long IMSI may have 0xFF for all bytes) or a null value (e.g., an empty string).

After invalidating the IMSI in the pSIM card or the eSIM profile, the SIM application may refresh (e.g., restart) the respective pSIM card or the eSIM profile and/or the wireless communication device. Subsequently, based on the IMSI in the pSIM card or the eSIM profile being invalid, the radio transceiver may refrain from requesting to connect to the home network. For instance, the radio transceiver may read the IMSI from the pSIM card or the eSIM profile. The radio transceiver may determine that the IMSI is invalid when the IMSI includes an invalid IMSI value (e.g., including all 0xFF or a null value).

In an embodiment, to ensure that the counter only counts consecutive network rejections that are due to the IMSI being unassociated with any active subscription registered with the home network of the wireless communication device, the SIM application may reset the counter whenever a received network rejection event is triggered by a rejection caused by a different reason than the IMSI being unassociated with any active subscription registered with the home network. In some instances, the radio transceiver may receive a network connection rejection due to errors in the transmission (e.g., when there is a high error rate in the network). Thus, the radio transceiver may receive an indication of a successful network connection for a network connection request transmitted after receiving a network connection rejection. In such instances, when the radio transceiver receives an acceptance or a success indication for a network connection request, the wireless communication device may also notify the SIM application of the network connection acceptance, and the SIM application may reset the counter. For instance, the SIM application may also register to be notified of a network connection acceptance or success.

In certain conditions, it may be desirable to restore a deactivated pSIM card or eSIM profile (e.g., after an action is taken to rectify the cause of the deactivation). In an embodiment, the SIM application may store a copy of the (original valid) IMSI in the pSIM card or the eSIM profile prior to setting the IMSI to the invalid IMSI value. Upon receiving a restore command, the SIM application may restore (or revert) the IMSI in the respective pSIM card or the eSIM profile to the copy of the IMSI (the original invalid IMSI). In an embodiment, the wireless communication device may include a SIM toolkit with a menu option (e.g., a user interface (UI)) for restoring a deactivated pSIM card or a deactivated eSIM profile, and the restore command may be received via the UI.

Monitoring for network connection rejections from a home network of a wireless communication device indicating an IMSI being unassociated with any active subscription registered with a network (or more specifically an HLR of the network) enables the wireless communication device to detect when a pSIM card or an eSIM profile at the wireless communication device is deactivated on the network side (e.g., by the MNO). Self-invalidating the IMSI in the pSIM card or the eSIM profile based on the respective pSIM card or the eSIM profile being deactivated (on the network side) can stop the wireless communication device from attempting to connect to the home network whenever the wireless communication device is turned on, and thus may conserve processing and network resources while saving on costs. Further, the conserved network resources can be allocated to other wireless communication devices that require network connectivity, and thus may improve the overall network performance. Self-invalidating the pSIM card or the eSIM profile only after receiving a threshold number of consecutive network rejections from the home network indicating the IMSI being unassociated with any active subscription registered with the HLR can avoid a false detection of the pSIM card or the eSIM profile being deactivated. Utilizing a configurable threshold value to limit the number of attempts the wireless communication device can request to connect to its home network after the pSIM card or the eSIM profile is deactivated provides flexibility for controlling network resource allocation and/or utilization (e.g., based on network conditions). For instance, the threshold value may be set to a higher value when the network condition is bad (e.g., a high error rate) and may be set to a lower value when the network condition is good (e.g., a low error rate). Configuring a SIM application to invalidate the pSIM card or the eSIM profile only modifies the SIM configuration, and thus can be adopted and implemented by an MNO without changing the underlying wireless communication protocol used for communicating with the network. Further, the mechanisms for self-invalidating a pSIM card or an eSIM profile after a respective subscription deactivation discussed herein may be applicable to any wireless communication protocols, for example, including, but are not limited to, second-generation (2G), third-generation (3G), fourth-generation (4G), fifth generation (5G), and/or sixth-generation (6G) as defined by 3rd generation partnership project (3GPP).

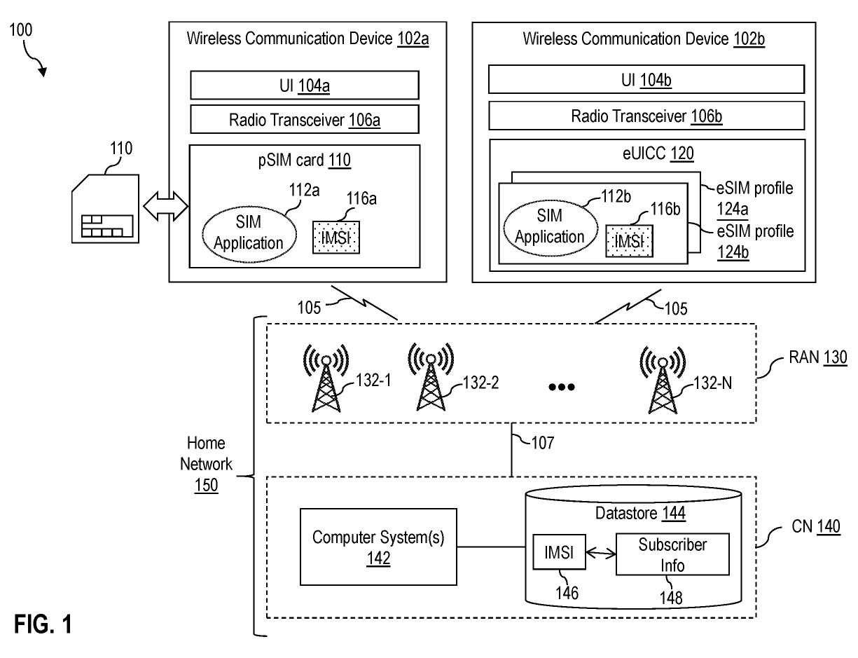

Turning now to FIG. 1, a network system 100 is described. The network system 100 includes a plurality of wireless communication devices 102, a RAN 130, and a CN 140. For simplicity, FIG. 1 illustrates two wireless communication devices 102a and 102b. However, the network system 100 may include any suitable number of wireless communication devices 102 (e.g., 10, 20, 100, 500 or more). The wireless communication devices 102 may also be referred to as user equipment (UEs). The wireless communication devices 102 may include mobile phones, smart phones, personal digital assistants, laptop computers, tablet computers, notebook computers, wearable computers, headset computers, Internet of Thing (IoT) devices, machine-type-communication devices, tracking devices, embedded wireless modules, and/or other wirelessly equipped communication devices (whether or not user operated). At a high level, the RAN 130 may connect the wireless communication devices 102 to the CN 140, and the CN 140 may connect the RAN 130 to other networks (e.g., one or more public networks, one or more private networks, or a combination thereof).

The RAN 130 may include a plurality of cell sites 132 (shown as 132-1, 132-2, …, 132-N, where N may be any suitable integer). In an embodiment, the RAN 130 may include tens of thousands or even hundreds of thousands of cell sites 132. A cell site 132 may be an access node (AN). The cell sites 132 may establish wireless communication links 105 with the wireless communication devices 102 for communication. In some examples, the wireless communication links 105 may be established according to a 6G, a 5G, a long-term evolution (LTE), a code division multiple access (CDMA), a global system for mobile communications (GSM) wireless telecommunication protocol, or some other suitable cellular communication protocol. In 5G and 6G technologies, an AN may be referred to as a next Generation Node B (gNB). In LTE technology, an AN may be referred to as an evolved Node B (eNB). In CDMA and GSM technology, an AN may be referred to as a base transceiver station (BTS) combined with a base station controller (BSC). In some contexts, an AN may be referred to as a cell tower.

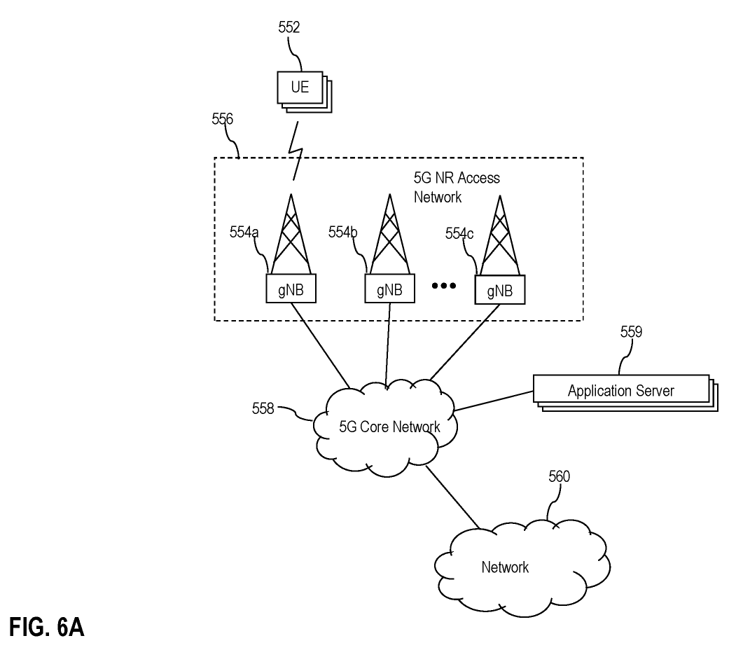

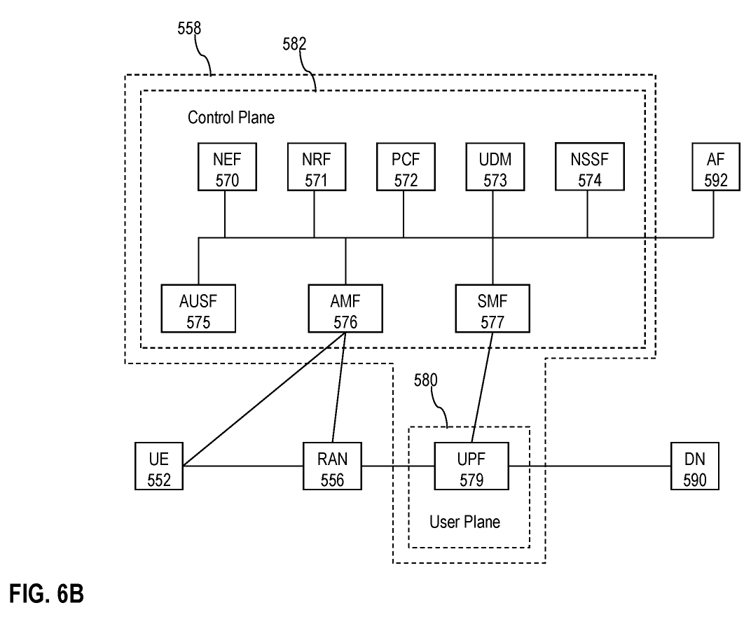

The CN 140 may be coupled to the RAN 130 via a backhaul link 107 (e.g., a wired link such as a copper link or a fiber link). The CN 140 may include a plurality of computer systems 142 (e.g., servers) to provide various network functions, such as access and security management, subscriber authentication, quality of service management, routing and communication control, interconnection with other networks (e.g., one or more public networks, one or more private networks, or a combination thereof). To facilitate subscriber authentication, the CN 140 may include a datastore 144 to store information associated with its customers. In some instances, the datastore 144 may be referred to as an HLR. For instance, the datastore 144 may store IMSIs 146, each identifying a subscriber of the CN 140. The datastore 144 may further store subscriber information 148 associated with each IMSI 146. In an example, the subscriber information 148 may indicate whether a respective IMSI 146 is active (e.g., corresponding to an active subscription) or inactive (e.g., corresponding to a deactivated subscription). In some examples, an IMSI 146 and associated subscriber information 148 may be deleted from the datastore 144 after a subscription associated with the respective IMSI 146 is deactivated (e.g., for a certain period of time). An example of a 5G network is discussed below with reference to FIGS. 6A and 6B.

In an example, the network system 100 may be operated by an MNO, and the wireless communication devices 102 may subscribe to services (e.g., voice and/or data communications, etc.) provided by the MNO. In other words, the RAN 130 and the CN 140 may be part of a home network 150 of the wireless communication devices 102. To store information related to a respective subscription at a wireless communication device 102, the wireless communication device 102 may include a SIM (e.g., a pSIM card or an eSIM profile). In the illustrated example of FIG. 1, the wireless communication device 102a includes a pSIM card 110 capable of being removed from or inserted into the wireless communication device 102a (as shown by the arrow), and the wireless communication device 102b includes a plurality of eSIM profiles 124 configured on an eUICC 120 that is embedded in (or integrated into) the wireless communication device 102b. For ease of illustration, FIG. 1 only illustrates two eSIM profiles 124a and 124b on the eUICC 120. However, an eUICC 120 may store any suitable number of eSIM profiles 124 (e.g., 1, 2, 3, 4 or more).

The pSIM card 110 in the wireless communication device 102a may include at least one processor (or a microcontroller) and at least one non-transitory memory. The pSIM card 110 may be configured with an IMSI 116a in the non-transitory memory. The IMSI 116a identifies the wireless communication device 102a in the home network 150 of the wireless communication device 102a. As an example, the IMSI 116a may be “310 260 123456789”, where “310” is the MCC, “260” is the MNC, and “123456789” is the MSIN. The pSIM card 110 may be further configured with a SIM application 112a (which may also be referred to as a SIM applet) including software instruction codes stored in the non-transitory memory. The SIM application 112a may be executable by the processor of the pSIM card 110 to perform tasks specific to the MNO. The pSIM card 110 may be further configured with other network information, for example, including an HPLMN identifier that identifies the home network 150 and a list of one or more EHPLMN identifiers that identifies one or more respective networks that may be considered by the wireless communication device 102a to be equivalent to the home network 150. The HPLMN identifier may correspond to the combination of the MCC and the MNC in the IMSI 116. In some instances, the non-transitory memory may be configured with a file system, and the IMSI 116a, the SIM application 112a, and the other network information may be stored as files in the file system.

The eUICC 120 in the wireless communication device 102b may include at least one processor (or a microcontroller) and at least one non-transitory memory. As discussed above, the eUICC 120 may include multiple eSIM profiles 124, each specific to a respective MNO. As an example, the wireless communication device 102b may have a subscription to a first MNO and a subscription to a second MNO different than the first MNO, where the eSIM profile 124a may be specific to the first MNO and the eSIM profile 124b may be specific to the second MNO. Generally, one eSIM profile 124 (e.g., the eSIM profile 124a or the eSIM profile 124b) may be active at a given time.

Each eSIM profile 124 may be stored in the non-transitory memory of the eUICC 120. Each eSIM profile 124 may include substantially the same type of information and data as the pSIM card 110. For instance, the eSIM profile 124a may include an IMSI 116b that identifies the wireless communication device 102b in the home network 150 of the wireless communication device 102b. The eSIM profile 124a may also include a SIM application 112b including software instruction codes. The SIM application 112b may be executable by the processor of the eUICC 120 (or another processor in the wireless communication device 102b) to perform tasks specific to the respective MNO. Generally, each eSIM profile 124 may store subscriber information (e.g., an IMSI 116) and a SIM application 112 associated with a respective MNO. In some instances, an eSIM profile 124 may be pre-loaded onto the eUICC 120. In other instances, an eSIM profile 124 may be downloaded (e.g., in the form of a software package) onto the eUICC 120 from a server of the CN 140 upon an activation of the respective eSIM profile 124.

In some instances, a user of a wireless communication device 102 may desire to switch from a first MNO to a second MNO. For the wireless communication device 102a, a first pSIM card 110 (associated with the first MNO) may be removed from the wireless communication device 102a, and a second pSIM card 110 (associated with the second MNO) may be inserted into the wireless communication device 102a. On the other hand, for the wireless communication device 102b, a first eSIM profile 124 (associated with the first MNO) may be deleted from the eUICC 120 and a second eSIM profile 124 (associated with the second MNO) may be downloaded onto the eUICC 120 without physically swapping a SIM card.

As further shown in FIG. 1, the wireless communication device 102a may include a radio transceiver 106a for communications with the RAN 130. For instance, the radio transceiver 106a may include a baseband transceiver, radio front-end (RF) circuitry, and one or more antennas. The radio transceiver 106a may establish a radio connection (e.g., a wireless communication link 105) with the RAN 130, for example, according to a certain wireless communication protocol. After establishing the radio connection, the radio transceiver 106a may perform a network connection procedure (e.g., including network registration and authentication) with the CN 140. As part of the network connection procedure, the radio transceiver 106a may transmit a network connection request to the CN 140, where the network connection request may include the IMSI 116a configured on the pSIM card 110. For instance, the radio transceiver 106a may be coupled to the pSIM card 110 and may read the IMSI 116a from the pSIM card 110. The CN 140 may accept or reject the network connection request. In an example, the network connection request may be rejected based on the IMIS 116a being unassociated with any active subscription registered with an HLR (e.g., the datastore 144) of the CN 140 (e.g., due to the pSIM card 110 being deactivated on the network side).

Similarly, the wireless communication device 102b may further include a radio transceiver 106b similar to the radio transceiver 106a for establishing a radio connection (e.g., a wireless communication link 105) with the RAN 130. Further, the radio transceiver 106b may request to connect to the CN 140 in a similar way as the radio transceiver 106a. For instance, the radio transceiver 106b may be coupled to the eUICC 120. The radio transceiver 106b may read the IMSI 116b from the eSIM profile 124a and transmit a network connection request including the read IMSI 116b to the CN 140.

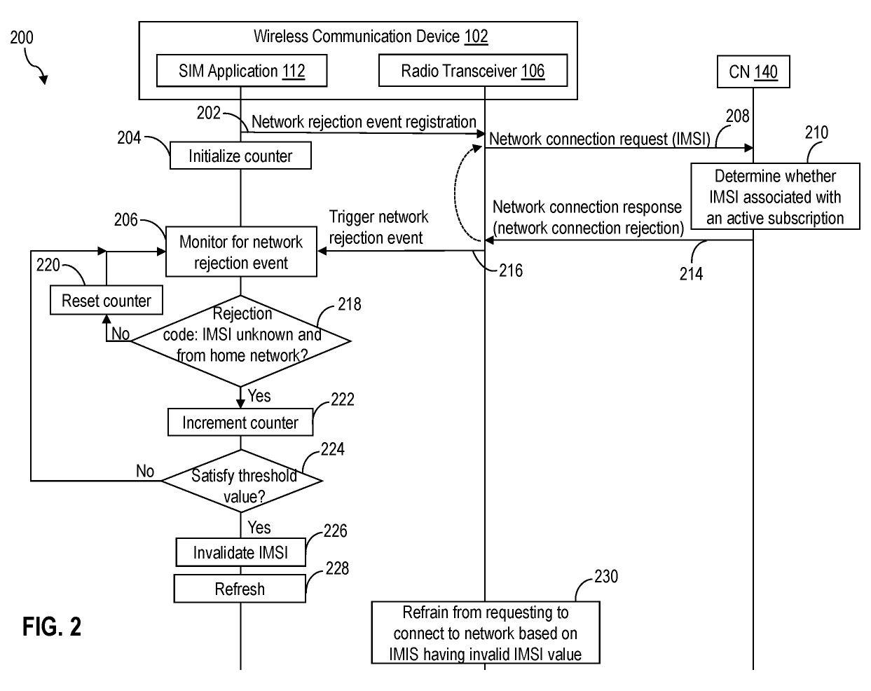

According to an embodiment of the present disclosure, the SIM application 112a on the pSIM card 110 in the wireless communication device 102a may be configured to identify when network connection requests are rejected by the home network 150 of the wireless communication device 102a due to the pSIM card 110 being deactivated (e.g., on the network side). The SIM application 112a may invalidate the IMSI 116a after receiving a certain number of consecutive network rejections due to the pSIM card 110 being deactivated. In a similar way, the SIM application 112b on the eSIM profile 124a in the wireless communication device 102b may be configured to identify when network connection requests are rejected by the home network 150 of the wireless communication device 102b due to the eSIM profile 124 being deactivated (e.g., on the network side). The SIM application 112b may invalidate the IMSI 116a after receiving a certain number of consecutive network rejections due to the eSIM profile 124a being deactivated (e.g., by setting the IMSI 116a to an invalid IMSI value). Mechanisms for self-invalidation of a pSIM card 110 and/or an eSIM profile 124 will be discussed more fully below with reference to FIGS. 2-5.

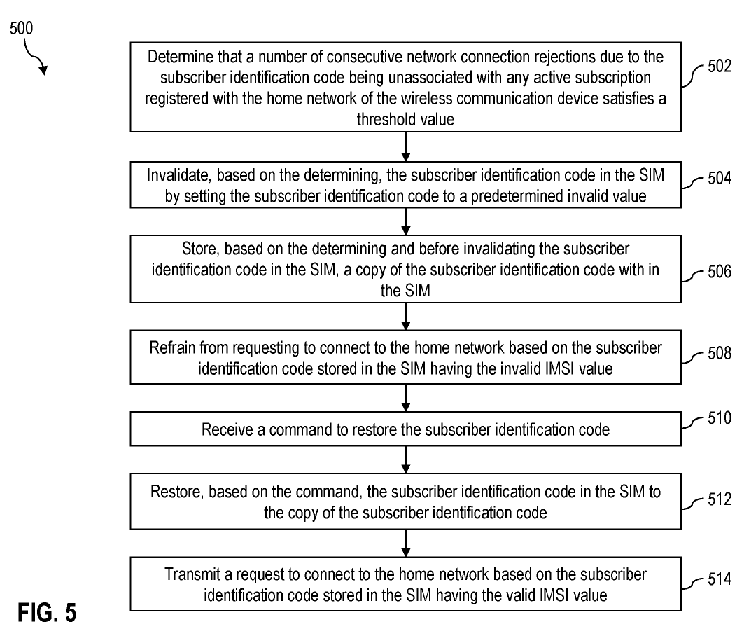

As further shown in FIG. 1, the wireless communication device 102a may include a UI 104a, and the wireless communication device 102b may include a UI 104b. In an embodiment, each of the UI 104a and 104b may include a SIM toolkit with a menu option to respectively restore a deactivated pSIM card 110 and a deactivated eSIM profile 124 (e.g., after an action is taken to rectify the cause of the deactivation). The SIM toolkit menu may be rendered by the SIM application 112a or the SIM application 112b, and a user of the wireless communication device 102a or the 102b may click on the menu option to respectively restore the deactivated pSIM card 110 or the deactivated eSIM profile 124. Mechanisms for restoring a deactivated SIM will be discussed more fully below with reference to FIG. 5.

FIG. 1 is merely an example of components of a network system that provides smart protection of home network resources by self-invalidation of a deactivated pSIM card or a deactivated eSIM profile in a wireless communication device, and variations are contemplated to be within the scope of the present disclosure. In embodiments, the network system may include other components not illustrated in FIG. 1. In embodiments, the network system may not include every component illustrated in FIG. 1. In embodiments, the components and connections may be implemented with different connections than those illustrated in FIG. 1. Such and other embodiments are contemplated to be within the scope of the present disclosure.

Turning now to FIG. 2, an example method 200 for providing smart protection of home network resources by self-invalidation of a SIM (e.g., the pSIM card 110 or the eSIM profile 124) at a wireless communication device is described. The method 200 illustrates operations performed by various components of the network system 100. Specifically, the components include a SIM application 112 and a radio transceiver 106 at a wireless communication device 102 and a CN 140. However, it is contemplated that other component(s) of the network system 100 may be involved in performing the operations of the method 300. For instance, all communications between the wireless communication device 102 and the CN 140 may be via the RAN 130. In one embodiment, the wireless communication device 102 may correspond to the wireless communication device 102a with the removable pSIM card 110 shown in FIG. 1, and the SIM application 112 and the radio transceiver 106 may correspond respectively to the SIM application 112a and the radio transceiver 106a. In another embodiment, the wireless communication device 102 may correspond to the wireless communication device 102b with an eSIM profile 124 (e.g., the eSIM profile 124a) configured on the eUICC 120 shown in FIG. 1, and the SIM application 112 and the radio transceiver 106 may correspond respectively to the SIM application 112b and the radio transceiver 106b. As illustrated, FIG. 2 includes a number of enumerated operations, but embodiments of the operations in FIG. 2 may include additional operations before, after, and in between the enumerated operations. In some embodiments, one or more of the enumerated operations may be omitted or performed in a different order.

At operation 202, the SIM application 112 transmits a network rejection event registration to the radio transceiver 106. The network rejection event registration may register the SIM application 112 to be notified when a network rejection is received from a network (e.g., the CN 140). As discussed above, the SIM application 112 may utilize a counter to track the number of consecutive network rejections due to the pSIM card 110 or the eSIM profile 124 in the wireless communication device 102 is deactivated. Accordingly, at operation 204, the SIM application 112 initializes a counter (e.g., to a value of zero). At operation 206, after initializing the counter, the SIM application 112 monitors for network rejection events.

In an embodiment, the pSIM card 110 or the eSIM profile 124 in the wireless communication device 102 may be deactivated on the network side (e.g., by the home network 150). Because the deactivation is from the network side, the pSIM card 110 or the eSIM profile 124 in the wireless communication device 102 may still include an IMSI 116 with a valid IMSI value (assigned for the original subscription). Thus, the radio transceiver 106 may read the IMSI 116 and may determine that the IMSI 116 is valid and proceed to request to connect to the CN 140. As shown, at operation 208, the radio transceiver 106 transmits a network connection request to connect to the CN 140. The radio transceiver 106 includes, in the network connection request, the IMSI 116 read from the pSIM card 110 or the eSIM profile 124. In general, the radio transceiver 106 may continue to attempt to connect to the CN 140 after receiving a network connection rejection (as shown by the dotted arrow). For example, the radio transceiver 106 may repeatedly transmit network connection requests regardless of whether one or more corresponding network connection rejections are received. In some instances, the radio transceiver 106 may utilize a timer to delay a subsequent network connection request attempt.

At operation 210, upon the CN 140 receiving the network connection request, the CN 140 determines whether the IMSI 116 is associated with any active subscription registered with the CN 140. To that end, the CN 140 may query the datastore 144 for information (e.g., subscription status) related to the received IMSI 116. In one example, the datastore 144 (the HLR) may include an IMSI 146 that matches the IMSI 116 and subscriber information 148 indicating that the subscription associated with the matched IMSI 146 is inactive or deactivated. In another example, the IMSI 116 is not stored in the datastore 144 (e.g., the IMSI 116 is deleted from the datastore 144 after a deactivation of a respective subscription). At operation 214, based on the deactivation information obtained from the datastore 144, the CN 140 transmits, to the wireless communication device 102, a network connection response indicating that the network connection request (received at operation 208) is rejected. For instance, the network connection response may include an indication of a network rejection due to the IMSI 116 being unassociated with any active subscription registered with the HLR (of the CN 140) and information identifying the CN 140 (that generated the network rejection). The indication of the network rejection may be in the form of a network rejection code (e.g., a numerical value).

In an example, the CN 140 may utilize various network rejection codes to indicate various network rejection reasons. A network rejection may be in response to a network connection request or a location update request from a wireless communication device 102. In a first example, a network rejection code of 12 (or another value) may indicate that a network connection request is rejected because the IMSI 116 requesting the network connection is unassociated with any active subscription registered with an HLR of the CN 140. In a second example, a network rejection code of 7 (or another value) may indicate that a general packet radio service (GPRS) service request is rejected because the subscriber (with the IMSI 116) requesting the GPRS service is not allowed to operate the GPRS service. In a third example, a network rejection code of 11 (or another value) may indicate that the subscriber requesting a location update in a PLMN is not allowed to operate in the PLMN. In a fourth example, a network rejection code of 13 (or another value) may indicate that the subscriber requesting a location update in a location area of a PLMN is not allowed to roam in the location area. In a fifth example, a network rejection code of 15 (or another value) may indicate that there is no suitable cell in a location area in which the subscriber requested a location update because the subscriber is not allowed to operate in the location area. In a sixth example, a network rejection code of 22 (or another value) may indicate that the rejection is because of network congestion. All the above example rejections except for the first example may cause a wireless communication device 102 to stop attempting to make the same request unless the wireless communication device 102 is power cycled according to current wireless communication protocols defined by 3GPP.

At operation 216, upon the radio transceiver 106 receiving the network connection response indicating the rejection, the radio transceiver 106 triggers a network rejection event including the reason for the rejection (e.g., in the form of a network rejection code, which may be a numerical value) and information (e.g., a combination of MCC and MNC) that identifies the CN 140 that rejected the network connection request. Because the SIM application 112 has registered to be notified of the network rejection event, the SIM application 112 may receive the triggered network rejection event as part of the monitoring at operation 206.

At operation 218, upon the SIM application 112 receiving the network rejection event, the SIM application 112 determines whether the network rejection is due to the IMSI 116 being unassociated with any active subscription registered with the CN 140 and whether the network rejection is received from a home network 150 of the wireless communication device 102. To determine whether the network rejection is due to the IMSI 116 being unassociated with any active subscription registered with the CN 140, the SIM application 112 may compare the network rejection code included in the network rejection event to the specific network rejection code (e.g., 12) that indicates a rejection being based on an IMSI 116 being unassociated with any active subscription registered with (an HLR of) the CN 140. To determine whether the network rejection is from the home network 150, the SIM application 112 may compare the MCC and the MNC included in the network rejection event respectively to the home MCC and the home MNC (of the home network 150) stored in the pSIM card 110 or the eSIM profile 124 of the wireless communication device 102. If there is a match between the MCC of the CN 140 and the home MCC and a match between the MNC of the CN 140 and the home MNC, then the CN 140 corresponds to the home network 150 of the wireless communication device. In an embodiment, the home MCC and the home MNC may be associated with a HPLMN of the wireless communication device 102. In another embodiment, the home MCC and the home MNC may be associated with an EHPLMN of the wireless communication device 102. In an example, if EHPLMN is included in the eSIM profile 124, the EHPLMN has a high priority than the HPLMN.

If the SIM application 112 determines that the network rejection is not due to the IMSI being unassociated with any active subscription registered with the CN 140 and/or that the CN 140 (that rejected the network connection request) is the home network 150, the SIM application 112 proceeds to operation 220. At operation 220, the SIM application 112 resets the counter (e.g., to a value of zero) and returns to operation 206 to monitor for network rejection events. If, however, the SIM application 112 determines that the network rejection is due to the IMSI being unassociated with any active subscription registered with the CN 140 and that the CN 140 (that rejected the network connection request) is the home network 150, the SIM application 112 proceeds to operation 222. At operation 222, the SIM application 112 increments the counter (e.g., by 1). At operation 224, the SIM application 112 determines whether the counter satisfies (e.g., reaches) a threshold value. The threshold value may represent the maximum number of consecutive network connection rejections that are due to the IMSI being unassociated with any active subscription registered with the home network 150 before the SIM application 112 may invalidate the IMSI 116.

In an embodiment, the threshold value may be a configurable threshold value. In one example, the threshold value may be configured based on a network condition (e.g., set to a higher threshold value when the network has a high error rate or congested). In another example, the threshold value may be configured based on the location of the wireless communication device 102 (e.g., set to a higher threshold value when the wireless communication device is in a remote location). In yet another example, the threshold value may be configured based on a last known connection time of the wireless communication device 102 (e.g., set to a higher threshold value when the last known connection time is more recent). The threshold value may be configured in a variety of ways. In one example, the threshold value may be programmatically adjusted by, for example, the SIM application 112, based on the aforementioned factors. The adjustment may be initiated from the CN 140. In other examples, the threshold value may be manually set or adjusted by the user of the wireless communication device 102.

If the SIM application 112 determines that the counter satisfies the threshold value, the SIM application 112 proceeds to operation 226. At operation 226, the SIM application 112 invalidates the IMSI 116 in the pSIM card 110 or the eSIM profile 124 by setting the IMSI 116 (in the pSIM card 110 or the eSIM profile 124) to an invalid IMSI value (e.g., including all 0xFF or a null value).

At operation 228, after invalidating the IMSI 116, the SIM application 112 refreshes (e.g., restarts) the pSIM card 110 or the eSIM profile 124 and/or the wireless communication device 102. In some instances, the refreshing may include a soft reset or restart of the pSIM card 110 or the eSIM profile 124 and/or the wireless communication device 102. In other instances, the refreshing may include turning the wireless communication device 102 off and then on and/or removing the pSIM card 110 from the wireless communication device 102 and re-inserting the pSIM card 110 back into the wireless communication device 102.

The radio transceiver 106 may continue to attempt to connect to the CN 140 after receiving a network connection rejection as long as the IMSI 116 in the pSIM card 110 or the eSIM profile 124 of the wireless communication device 102 is valid. At operation 230, the radio transceiver 106 refrains from requesting to connect to the CN 140 (e.g., bypassing a network connection request transmission) based on the IMSI 116 (in the pSIM card 110 or the eSIM profile 124) having an invalid IMSI value. For instance, the radio transceiver 106 may read the IMSI 116 from the pSIM card 110 or the eSIM profile 124 and determine that the IMSI 116 is invalid (e.g., having the invalid IMSI value).

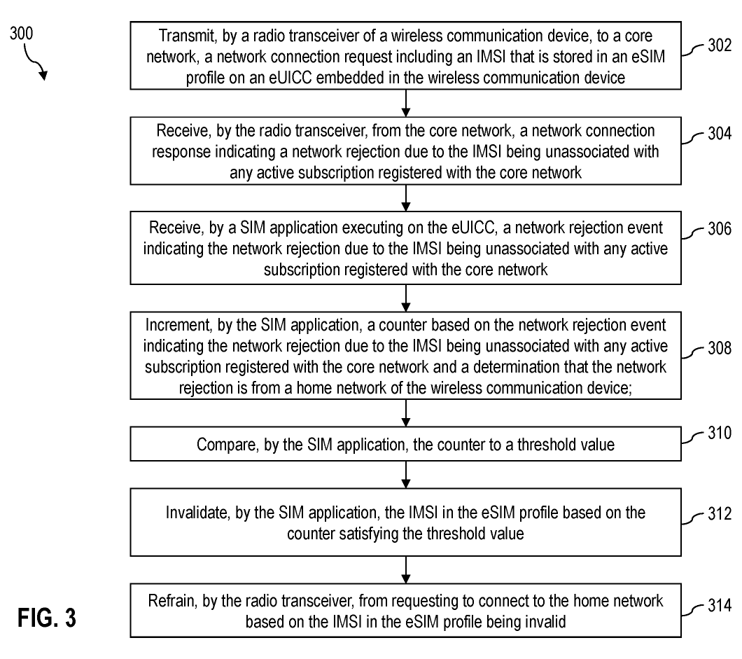

Turning now to FIG. 3, a method 300 is described. In an embodiment, the method 300 is a method of protecting home network resources by self-invalidating an eSIM profile 124 at a wireless communication device 102. The method 300 may include similar mechanisms as discussed above with reference to FIGS. 1-2. As illustrated, FIG. 3 includes a number of enumerated operations, but embodiments of the operations in FIG. 3 may include additional operations before, after, and in between the enumerated operations. In some embodiments, one or more of the enumerated operations may be omitted or performed in a different order.

At block 302, a radio transceiver 106 of a wireless communication device 102 transmits, to a CN 140, a network connection request including an IMSI 116 that is stored in an eSIM profile 124 on an eUICC 120 of the wireless communication device 102. At block 304, the radio transceiver 106 receives, from the CN 140, a network connection response indicating a network rejection due to the IMSI 116 being unassociated with any active subscription registered with the CN 140 (or more specifically to an HLR of the CN 140).

At block 306, a SIM application 112 executing on the eUICC 120 receives a network rejection event indicating the network rejection due to the IMSI 116 being unassociated with any active subscription registered with the CN 140. At block 308, the SIM application 112 increments a counter based on the network rejection event indicating the network rejection due to the IMSI 116 being unassociated with any active subscription registered with the CN 140 and a determination that the network rejection is from a home network 150 of the wireless communication device 102, where the CN 140 is part of the home network 150. At block 310, the SIM application 112 compares the counter to a threshold value. In an embodiment, the threshold value is a number of consecutive network rejections due to the IMSI 116 being unassociated with any active subscription registered with the home network 150 of the wireless communication device 102. In an embodiment, the threshold value is a configurable threshold value in the eSIM profile 124. At block 312, the SIM application 112 invalidates the IMSI 116 in the eSIM profile 124 based on the counter satisfying the threshold value. In an embodiment, as part of invalidating the IMSI 116, the SIM application 112 sets the IMSI 116 in the eSIM profile 124 to an invalid IMSI value including at least one of a value of 0xFF or a null value.

At block 314, the radio transceiver 106 refrains from requesting to connect to the home network 150 based on the IMSI 116 in the eSIM profile 124 being invalid. In an embodiment, the refraining from requesting to connect to the CN 140 is subsequent to a restart of at least one of the wireless communication device 102 or the eSIM profile 124.

In an embodiment, the SIM application further receives a second network rejection event. Based on the second network rejection event is due to a different reason than the IMSI 116 being unassociated with any active subscription registered with the home network 150 of the wireless communication device 102, the SIM application 112 resets the counter to a value of zero. In this way, the counter only counts (or increments the counter) based on consecutive network rejections from the home network that are due to the IMSI being unassociated with any active subscription registered with the home network.

In an embodiment, the SIM application 112 further registers to be notified of the network rejection event, and the radio transceiver 106 triggers the network rejection event based on the network connection rejection received from the CN 140 at block 304. In an embodiment, the network connection response includes a network rejection code indicative of the network connection request being rejected based on the IMSI 116 being unassociated with any active subscription registered with the CN 140 and an MCC and an MNC associated with the CN 140 that rejected the network connection request. Accordingly, the radio transceiver 106 may include, in the network rejection event, the network rejection code and the MCC and the MNC associated with the CN 140. In an embodiment, the SIM application 112 further determines that the network connection rejection is from the home network 150 of the wireless communication device 102 based on a match between the MCC associated with the CN 140 and an MCC in the eSIM profile 124 and a match between the MNC associated with the CN 140 and an MNC in the eSIM profile 124. In an embodiment, the IMSI 116 being unassociated with any active subscription registered with the CN 140 is based on a deactivation of a subscription of the wireless communication device 102 to the home network 150.

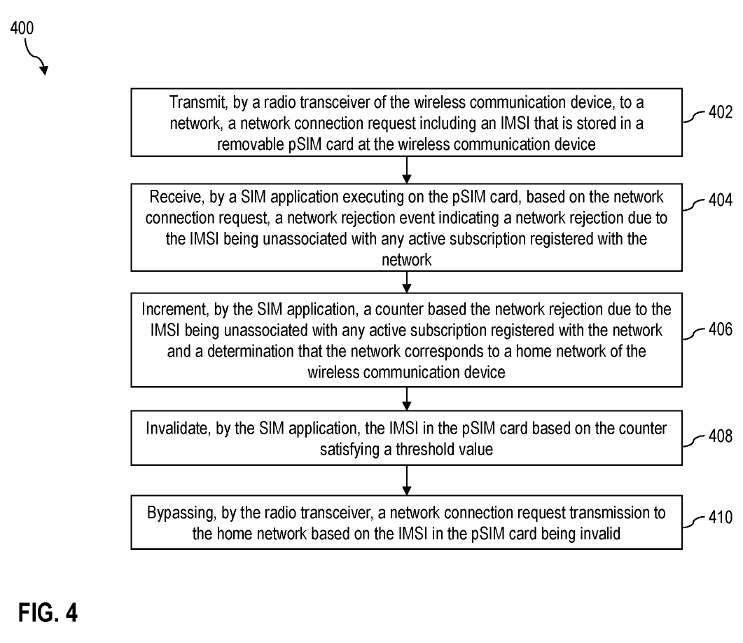

Turning now to FIG. 4, a method 400 is described. In an embodiment, the method 400 is a method of protecting home network resources by self-invalidating a pSIM card 110 at a wireless communication device 102. The method 400 may include similar mechanisms as discussed above with reference to FIGS. 1-3. As illustrated, FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At block 402, a radio transceiver 106 of a wireless communication device 102 transmits, to a network (e.g., the CN 140), a network connection request including an IMSI 116 that is stored in a removable pSIM card 110 at the wireless communication device 102. At block 404, a SIM application 112 executing on the pSIM card 110 receives, based on the network connection request, a network rejection event indicating a network rejection due to the IMSI being unassociated with any active subscription registered with the network (or more specifically to an HLR of the network). In an embodiment, the IMSI being unassociated with any active subscription registered with the network is based on a deactivation of a subscription of the wireless communication device 102 to the home network 150.

At block 406, the SIM application 112 increments a counter based on the network rejection due to the IMSI being unassociated with any active subscription registered with the network and a determination that the network corresponds to a home network of the wireless communication device. At block 408, the SIM application 112 invalidates the IMSI 116 in the pSIM card 110 based on the counter satisfying a threshold value. At block 410, the radio transceiver 106 bypasses a network connection request transmission to the home network 150 based on the IMSI in the pSIM card 110 being invalid. In an embodiment, the threshold value is a number of consecutive network rejections due to the IMSI 116 being unassociated with any active subscription registered with the home network 150 of the wireless communication device 102. In an embodiment, the threshold value is a configurable threshold value in the pSIM card 110. In an embodiment, as part of invalidating the IMSI 116, the SIM application 112 sets the IMSI 116 in the pSIM card 110 to an invalid IMSI value including at least one of a value of 0xFF or a null value.

In an embodiment, the network rejection event includes an MCC and an MNC associated with the network that generated the network rejection. The SIM application 112 further determines that the network rejection is from the home network 150 of the wireless communication device 102 based on a comparison between the MCC associated with the network and an MCC stored in the pSIM card 110 and a comparison between the MNC associated with the network and an MNC stored in the pSIM card 110.

In an embodiment, in response to the network connection request transmitted at block 402, the radio transceiver 106 further receives, from the network, a network connection response indicating the network rejection due to the IMSI being unassociated with any active subscription registered with the network. The radio transceiver 106 further triggers the network rejection event based on the network rejection received from the network, where the network rejection event received at block 404 is based on the trigger.

Turning now to FIG. 5, a method 500 is described. In an embodiment, the method 500 is a method of restoring an invalidated SIM at a wireless communication device 102. The method 500 may include similar mechanisms as discussed above with reference to FIGS. 1-4. As illustrated, FIG. 5 includes a number of enumerated operations, but embodiments of the operations in FIG. 5 may include additional operations before, after, and in between the enumerated operations. In some embodiments, one or more of the enumerated operations may be omitted or performed in a different order.

In the method 500, the wireless communication device 102 may include a SIM to store a subscriber identification code (e.g., an IMSI 116) associated with the wireless communication device 102. In an embodiment, the SIM corresponds to a pSIM card 110 capable of being removed from the wireless communication device 102. In another embodiment, the SIM corresponds to an eSIM profile 124 stored in an eUICC 120 embedded in the wireless communication device 102. At block 502, a SIM application 112 executing on the wireless communication device 102 determines that a number of consecutive network connection rejections due to a subscriber identification code being unassociated with any active subscription registered with a home network 150 of the wireless communication device 102 satisfies a threshold value. At block 504, the SIM application 112 stores, based on the determining at block 502, in the SIM, a copy of the subscriber identification code having a valid subscriber identification code value. At block 506, the SIM application 112 invalidates, based on the determining at block 502, the subscriber identification code in the SIM by setting the subscriber identification code to an invalid subscriber identification code value (after the storing at block 504). At block 508, based on the subscriber identification code stored in the SIM having the invalid IMSI value, a radio transceiver 106 of the wireless communication device 102 refrains from requesting to connect to the home network 150 of the wireless communication device 102.

At block 510, the SIM application 112 receives a command to restore the subscriber identification code in the SIM. In an embodiment, the command may be received from a UI 104 (e.g., a SIM toolkit menu option) at the wireless communication device 102. At block 512, the SIM application 112 restores, based on the received command, the subscriber identification code in the SIM to the stored copy of the subscriber identification code. At block 514, the radio transceiver 106 transmits, to the home network 150 after the restoring, a network connection request based on the subscriber identification code in the SIM has the valid subscriber identification code value. For instance, the radio transceiver 106 may read the subscriber identification code from the SIM and determine that the subscriber identification code in the SIM card has the valid subscriber identification code value.

Turning now to FIG. 6A, an exemplary communication system 550 is described. Typically the communication system 550 includes a number of access nodes ANs 554 that are configured to provide coverage in which UEs 552 such as cell phones, tablet computers, machine-type-communication devices, tracking devices, embedded wireless modules, and/or other wirelessly equipped communication devices (whether or not user operated), can operate. The ANs 554 may be said to establish an access network 556. The access network 556 may be referred to as a radio access network (RAN) in some contexts. In a 5G technology generation an AN 554 may be referred to as a next Generation Node B (gNB). In 4G technology (e.g., LTE technology) an AN 554 may be referred to as an evolved Node B (eNB). In 3G technology (e.g., CDMA and global system for mobile communication (GSM)) an AN 554 may be referred to as a base transceiver station (BTS) combined with a BSC. In some contexts, the AN 554 may be referred to as a cell site or a cell tower. In some implementations, a picocell may provide some of the functionality of an AN 554, albeit with a constrained coverage area. Each of these different embodiments of an AN 554 may be considered to provide roughly similar functions in the different technology generations.

In an embodiment, the access network 556 comprises a first AN 554a, a second AN 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an AN 554 and could thereby communicate via the AN 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G” - such as LTE, which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive IoT. 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general Internet service providers for laptops and desktop computers, competing with existing ISPs such as cable Internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 6B, an example CN 558 is described. In an embodiment, the CN 558 may correspond to the CN 140 of FIG. 1. In an embodiment, the CN 558 is a 5G CN. 5G CN technology is based on a service-based architecture paradigm. Rather than constructing the 5G CN as a series of special purpose communication nodes (e.g., a home subscriber server (HSS) node, a mobility management entity (MME) node, etc.) running on dedicated server computers, the 5G CN is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G CN 558 may be segregated into a user plane 580 and a control plane 582, thereby promoting independent scalability, evolution, and flexible deployment.

The UPF 579 delivers packet processing and links a UE 552 (e.g., the wireless communication device 102 illustrated in FIG. 1), via the access network 556 (e.g., the RAN 130 illustrated in FIG. 1), to a data network 590 (e.g., the network 560 illustrated in FIG. 6A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and Internet protocol (IP) address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow-based charging control. The UDM 573 manages network user data and can be paired with a user data repository (UDR) (e.g., the datastore 144 illustrated in FIG. 1) that stores user data such as customer profile information, customer authentication number, and encryption keys for the information. An application function 592, which may be located outside of the CN 558, exposes the application layer for interacting with the CN 558. In an embodiment, the application function 592 may be executed on an application server located geographically proximate to the UE 552 in an “edge computing” deployment mode. The CN 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

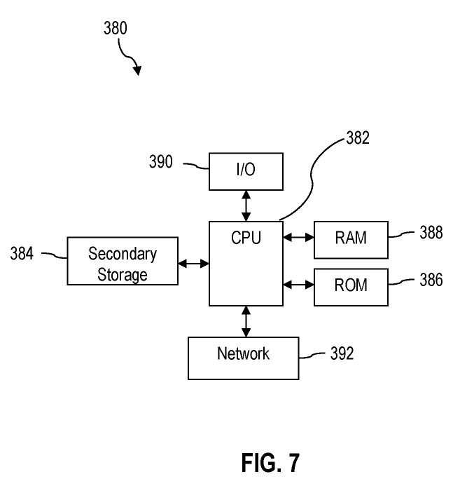

FIG. 7 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), IP, time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of protecting home network resources by self-invalidating an embedded subscriber identity module (eSIM) profile at a wireless communication device, the method comprising:
transmitting, by a radio transceiver of the wireless communication device, to a core network, a network connection request comprising an international mobile subscriber identity (IMSI) that is stored in an eSIM profile on an embedded universal integrated circuit card (eUICC) of the wireless communication device;
receiving, by the radio transceiver, from the core network, a network connection response indicating a network rejection due to the IMSI being unassociated with an active subscription registered with the core network;
receiving, by a SIM application executing on the eUICC, a network rejection event indicating the network rejection due to the IMSI being unassociated with an active subscription registered with the core network;
incrementing, by the SIM application, a counter based on the network rejection event indicating the network rejection due to the IMSI being unassociated with an active subscription registered with the core network and a determination that the network rejection is from a home network of the wireless communication device, wherein the core network is associated with the home network;
comparing, by the SIM application, the counter to a threshold value;
invalidating, by the SIM application, the IMSI in the eSIM profile based on the counter satisfying the threshold value; and
refraining, by the radio transceiver, from requesting to connect to the home network based on the IMSI in the eSIM profile being invalid.

2. The method of claim 1, wherein the threshold value is a number of consecutive network rejections due to the IMSI being unassociated with an active subscription registered with the home network of the wireless communication device.

3. The method of claim 1, wherein the threshold value is a configurable threshold value stored in the eSIM profile.

4. The method of claim 1, wherein the invalidating the IMSI in the eSIM profile comprises:
setting, by the SIM application, the IMSI in the eSIM profile to an invalid IMSI value comprising a value of 0xFF.

5. The method of claim 1, wherein the invalidating the IMSI in the eSIM profile comprises:
setting, by the SIM application, the IMSI in the eSIM profile to an invalid IMSI value comprising a null value.

6. The method of claim 1, further comprising:
receiving by the SIM application, a second network rejection event; and
resetting, by the SIM application, the counter to a value of zero based on the second network rejection event is due to a different reason than the IMSI being unassociated with an active subscription registered with the home network of the wireless communication device.

7. The method of claim 1, wherein:
the network rejection event comprises:
a network rejection code indicative of the network connection request being rejected based on the IMSI being unassociated with an active subscription registered with the core network; and
a mobile country code (MCC) and a mobile network code (MNC) associated with the core network that rejected the network connection request, and
the method further comprises:
determining, by the SIM application, that the network rejection is from the home network of the wireless communication device based on:
a match between the MCC associated with the core network and an MCC in the eSIM profile; and
a match between the MNC associated with the core network and an MNC in the eSIM profile.

8. The method of claim 1, further comprising:
registering, by the SIM application, to be notified of the network rejection event; and
triggering, by the radio transceiver, the network rejection event based on the network rejection received from the core network.

9. The method of claim 1, wherein the IMSI being unassociated with an active subscription registered with the core network is based on a deactivation of the eSIM profile in the home network.

10. The method of claim 1, wherein the refraining from requesting to connect to the core network is subsequent to a restart of at least one of the wireless communication device or the eSIM profile.

11. A wireless communication device comprising:
a subscriber identity module (SIM) to store a subscriber identification code associated with the wireless communication device;
a UI;
at least one processor;
at least one non-transitory memory; and
a SIM application comprising instructions stored in the at least one non-transitory memory, which when executed by the at least one processor, causes the SIM application to:
determine that a number of consecutive network connection rejections due to the subscriber identification code being unassociated with an active subscription registered with a home network of the wireless communication device satisfies a threshold value;
store, based on the determining, in the SIM, a copy of the subscriber identification code having a valid subscriber identification code value;
invalidate, based on the determining, the subscriber identification code in the SIM by setting the subscriber identification code to an invalid subscriber identification code value after storing the copy of the subscriber identification code;
receive, via the UI, a command to restore the subscriber identification code in the SIM;
restore, based on the command, the subscriber identification code in the SIM to the stored copy of the subscriber identification code; and
a radio transceiver to:
refrain from requesting to connect to the home network based on the subscriber identification code in the SIM having the invalid subscriber identification code value; and
transmit, to the home network, a network connection request based on the subscriber identification code in the SIM being restored to the valid subscriber identification code value.

12. The wireless communication device of claim 11, wherein the SIM is a physical subscriber identity module (pSIM) card capable of being removed from the wireless communication device.

13. The wireless communication device of claim 11, further comprising:
an embedded universal integrated circuit card (eUICC),
wherein the SIM is an embedded subscriber identity module (eSIM) profile configured on the eUICC.

14. The wireless communication device of claim 11, wherein the subscriber identification code is an international mobile subscriber identity (IMSI).

15. The wireless communication device of claim 11, wherein the invalid subscriber identification code value for invalidating the subscriber identification code in the SIM comprises a value of 0xFF or a null value.

16. A method comprising:
transmitting, by a radio transceiver of the wireless communication device, to a network, a network connection request comprising an international mobile subscriber identity (IMSI) that is configured on a removable physical subscriber identity module (pSIM) card at the wireless communication device;
receiving, by a SIM application executing on the pSIM card, based on the network connection request, a network rejection event indicating a network rejection due to the IMSI being unassociated with an active subscription registered with the network;
incrementing, by the SIM application, a counter based on the network rejection due to the IMSI being unassociated with an active subscription registered with the network and a determination that the network corresponds to a home network of the wireless communication device;
invalidating, by the SIM application, the IMSI in the pSIM card based on the counter satisfying a threshold value; and
bypassing, by the radio transceiver, a network connection request transmission to the home network based on the IMSI in the pSIM card being invalid.

17. The method of claim 16, wherein the threshold value is a number of consecutive network rejections due to the IMSI being unassociated with an active subscription registered with the home network of the wireless communication device.

18. The method of claim 16, wherein the invalidating the IMSI in the pSIM card comprises:
setting, by the SIM application, the IMSI in the pSIM card to an invalid IMSI value comprising a value of 0xFF or a null value.

19. The method of claim 16, wherein:
the network rejection event comprises a mobile country code (MCC) and a mobile network code (MNC) associated with the network that generated the network rejection, and
the method further comprises:
determining, by the SIM application, that the network rejection is from the home network of the wireless communication device based on:
a comparison between the MCC associated with the network and an MCC configured on the pSIM card; and
a comparison between the MNC associated with the network and an MNC configured on the pSIM card.

20. The method of claim 16, further comprising:
registering, by the SIM application, to be notified of the network rejection event;
receiving, by the radio transceiver, from the network, a network connection response indicating the network rejection due to the IMSI being unassociated with an active subscription registered with the network; and
triggering, by the radio transceiver, the network rejection event based on the network rejection received from the network.
